(19) United States
(12) Patent Application Publication
(10) Pub. No.: US 2007/0164549 A1
(43) Pub. Date: Jul. 19, 2007

(54) Steering column arrangement

(75) Inventors: Christian Bastein, Neu-Wulmstorf (DE); Fred Eggers, Buxtehude (DE); Holger Kittler, Hamburg (DE); Wolfgang Schuliers, Buchholz (DE); Joerk Tatulinski, Hamburg (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/572,318

(22) PCT Filed: Sep. 3, 2004
(86) PCT No.: PCT/EP04/09828

§ 371 Date: Mar. 1, 2007

(30) Foreign Application Priority Data
Sep. 19, 2003 (DE) 103 43 399.6

(51) Int. Cl. B62D 1/18; B62D 1/00

(52) U.S. Cl. 280/777; 280/779; 280/775

(57) ABSTRACT

A steering column arrangement has a console arranged fixedly with respect to the vehicle and a steering column which has a steering column tube and a steering spindle mounted rotatably in the latter. The steering column is designed to be variable in its inclination and length, and a clamp for securing the steering column is provided. In order to increase the safety of the vehicle occupants, while at the same time maintaining known comfort functions, and to ensure a reliable use of the steering column arrangement, it is proposed to connect the steering column to the console by the clamp via a console slide which is mounted displaceably on the console. Furthermore, an actuation element operatively connected to the clamp is provided for releasing and locking the clamp, and the operative connection is releasable.

### BACKGROUND AND SUMMARY OF THE INVENTION

This invention relates to a steering column arrangement.

In modern vehicle construction, steering columns are designed in such a way that they can be varied in their inclination and length for comfort purposes. They can consequently be set to the individual requirements of the driver. Clamping means are provided for fixing the steering column in its position. A steering column of this type is known, for example, from European publication EP 0 802 104 A1. The steering column described in this publication has a console which is fixed with respect to the vehicle and on which clamping means in the form of lamellae are mounted. The steering column is connected via these clamping means to the console fixed with respect to the vehicle. In an opening position of the clamping means, it is possible to displace the steering column with respect to the console. In a closing position of the clamping means, the steering column is secured with respect to the console. In this case, the clamping means are to be designed such that they reliably and permanently block the variability in position of the steering column. This applies particularly to the situation where a force acting in the axial direction, such as, for example, in the event of an accident, is applied to the steering column. On the other hand, the clamping means must be designed such that they make it possible in a simple way to vary the position of the steering column, as required.

In order to make steering column arrangements safe for a vehicle impact, it is known to fasten a steering column of non-adjustable position to a console arranged fixedly with respect to the vehicle, such that, in the event of an accident, an axial displacement of the steering column in relation to the console, at the same time with the absorption of energy, is possible. In this respect, reference is made, for example, to German document DE 37 20 320 A1. A steering column arrangement having a console arranged fixedly with respect to the vehicle may be gathered from this publication. A steering column non-adjustable for reasons of comfort is disclosed, which is connected to the console via a yoke. Bolts are provided, which engage into long hole bores introduced into the yoke and, in the event of an accident, allow a displacement of the yoke in relation to the console, at the same time with the absorption of energy. There is, then, interest in implementing a longitudinal displacement of the steering column in the event of a crash, even in the case of steering columns which are adjustable for reasons of comfort.

The object on which the present invention is based is, therefore, to provide a steering column arrangement in which, while known comfort functions are preserved, the safety of vehicle occupants is increased and a reliable use of the steering column arrangement is ensured.

This object is achieved, according to the invention, by means of a steering column arrangement having the features claimed.

The solution according to the invention is distinguished by a steering column arrangement with a console arranged fixedly with respect to the vehicle, and a steering column which is designed to be variable in its inclination and length for reasons of comfort. In order to secure the steering column in its position, moreover, clamping means are provided. So as to increase the safety of vehicle occupants in the event of a crash, a console slide is arranged between the console arranged fixedly with respect to the vehicle and the steering column with the clamping means. The console slide is connected to the console such that a linear displacement of the console slide along the console is possible. According to the invention, an actuation element for releasing and locking the clamping means is provided, which is operatively connected to the clamping means. The operative connection is in this case designed releasably.

The possibility of releasing the connection between the actuation element and the clamping means affords the advantage that, after the release of the connection, the position of the clamping means can be secured and the actuation element can be moved independently of the clamping means. A release of the operative connection between the actuation element and the clamping means causes a “freezing” of the position of the clamping means, because the clamping means cannot readily be varied without the actuation element. It is thus possible, for example, to ensure that, in specific situations, a release of the clamping means does not take place, even though the actuation element is moved. Such a situation may arise, for example, in the event of an accident, when the steering column has applied to it a force acting in the axial direction, by means of which the steering column is displaced. In such a case, it is necessary to ensure that the clamping means are not released, because this would result in an uncontrolled, in particular resistanceless forward movement of the steering column, without the absorption of energy.

According to one embodiment, the release of the operative connection between the actuation element and the clamping means takes place in the event of a displacement of the console slide in relation to the console. A displacement of the console slide in relation to the console takes place, as a rule, in the event of a force applied axially to the steering column, as occurs, for example, in the event of an accident. In this situation, it is important that the clamping means maintain their locking position. If, then, the operative connection between the actuation element and the clamping means is released when the console slide is displaced in relation to the console, it is ensured that the clamping means maintain their locking position and therefore the clamping means maintain the steering column position, once this is secured. This ensures that the steering column executes controlled movement. The movement occurs only as a result of a displacement of the console slide in relation to the console. All the other elements of the steering column arrangement maintain their position. This ensures that the displacement takes place in a defined way, that is to say, in particular, via a definedly set force reduction.

The clamping means may be lamellae which overlap one another and through which a tension bolt passes. Via lamellae, a defined frictional force can be built up, which ensures that the steering column arrangement is secured reliably, and at the same time ensures that a simple release of the clamping means is possible.

The tension bolt may have arranged on it known tension means, such as, for example, disks which are displaceable with respect to one another and which exert pressure on the lamellae via the tension bolt as a function of their position in relation to one another.

The actuation element may be, for example, a lever. The lever may in this case be arranged such that one of its ends points in the direction of the vehicle interior and can therefore easily be handled by a vehicle occupant. The other end of the lever may cooperate with the tension means. Depending on the position which the lever assumes, the tension means are transferred from an opening position into a closing position, or vice versa.

It is conceivable for the connection between the actuation lever and the tension means to be of positive design. A positive connection affords the advantage that the force necessary for releasing the connection can be set exactly. This offers the advantage that a defined tear-off force can be set.

The actuation lever may have, for example, a u-shaped receptacle for a corresponding connection element of the tension means. The u-shaped receptacle may be designed, for example, as a dihedron. A dihedron affords the advantage that a frictional connection can be made, which has an influence on the release behavior, in particular on the release-opposed resistance of the operative connection between the actuation lever and tension means.

The receptacle is advantageously oriented such that, in the event of a displacement of the console slide in relation to the console, a release of the connection between the actuation lever and tension means can be carried out. For this purpose, the open end of the u-shaped receptacle may be oriented in the direction in which the console slide moves in relation to the console.

So that the lever is not moved together with the console slide during a displacement of the console slide in relation to the console, but, instead, the operative connection between the actuation lever and tension means is released, the lever may have a dog which is oriented such that it comes to bear against the console in the event of a displacement of the console slide, with the result that a further displacement of the lever is prevented. If, then, the console slide is moved further, the connection between the lever and tension means is released.

The invention is explained in more detail below with reference to exemplary embodiments illustrated in the drawings.

### BRIEF DESCRIPTION OF THE DRAWINGS

FIG. 1 shows a three-dimensional illustration of a steering column arrangement according to the invention before an impact;

FIG. 2 shows a three-dimensional illustration of the steering column arrangement according to the invention, as shown in FIG. 1, after an impact;

FIG. 3 shows a three-dimensional illustration of an actuation lever according to the invention;

FIG. 4 shows a three-dimensional illustration of the actuation lever according to the invention, as shown in FIG. 3, from the opposite side, and

FIG. 5 shows a diagrammatic illustration of a further embodiment of an actuation lever according to the invention.

### DETAILED DESCRIPTION OF THE INVENTION

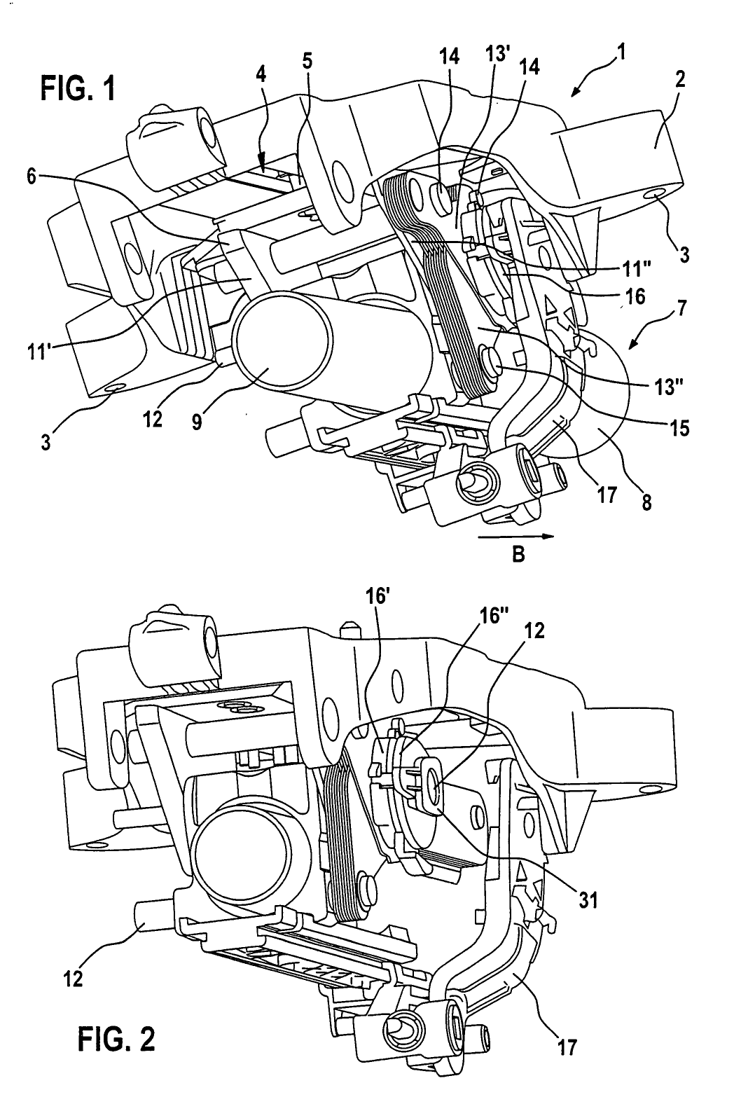

FIG. 1 illustrates a steering column arrangement 1. The steering column arrangement 1 has a console 2 arranged fixedly with respect to the vehicle. The console 2 has an essentially rectangular cross section. It has receptacles 3 for fastening means, not illustrated in any more detail. The console 2 is mounted on a vehicle, likewise not illustrated, via these fastening means. Furthermore, the console 2 has a long hole 4 which extends over a large part of the length of the console 2. In the long hole 4, a link block 5 is arranged, via which a console slide 6 is mounted on the console 2. The connection of the console slide 6 via the link block 5 mounted in the long hole 4 allows a displacement of the console slide 6 in relation to the console 2 fixed with respect to the vehicle. The displacement travel is predetermined by the length and orientation of the long hole 4.

The steering column arrangement 1 has, furthermore, a steering column 7 with a steering column tube 8 and with a steering spindle 9 mounted rotatably in the steering column tube 8. The steering spindle 9 serves for receiving a steering wheel, not illustrated, and for transmitting a rotational movement introduced into the steering wheel by a driver to a steering gear. The console slide 6 has, on its side facing away from the console 2, two cheeks 11′ and 11″, between which the steering column tube 8 is arranged. For this purpose, a clamping bolt 12 passes through both the cheeks 11′ and 11″ and the steering column tube 8. Outside the cheek 11′, two sets of lamellae 13′ and 13″ are arranged, which overlap one another and through which the clamping bolt 12 likewise passes, although this is not illustrated in FIG. 1. In this case, the set of lamellae 13′ is connected to the cheek 11″ via bolts 14. The set of lamellae 13″, in turn, is connected to the steering column tube 8 via bolts 15.

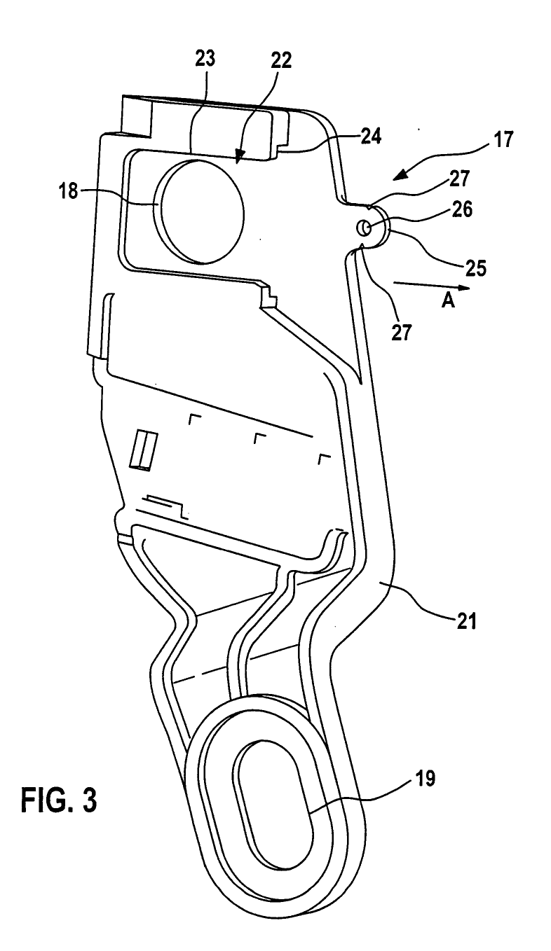

Attached respectively to the sets of lamellae 13′ and 13″ are tension means 16 through which the tension bolt 12 likewise passes. The tension means 16 consist of two disks 16′ and 16″ displaceable in relation to one another (cf. FIG. 2). By means of balls arranged between the disks and running in link tracks introduced into the disks 16′ and 16″, the distance between the disks is varied as soon as these are moved in relation to one another. The movement of the disks 16′ and 16″ in relation to one another takes place as a rotational movement which the disk 16″ executes in relation to the disk 16′ around the clamping bolt. As a function of the position of the two disks 16′ and 16″ in relation to one another, the clamping means assume either an open position, in which a displacement and pivoting of the steering column 7 is possible, or a closed position, in which the position of the steering column 7 is secured. When there is a minimum distance between the disks 16′ and 16″, the open position is adopted; when there is a maximum distance between the disks 16′ and 16″, the closed position is adopted.

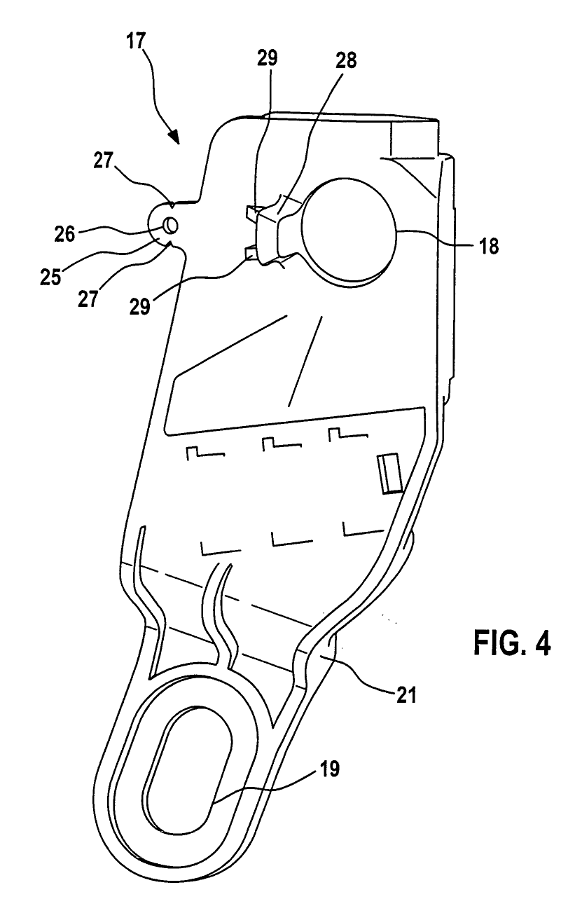

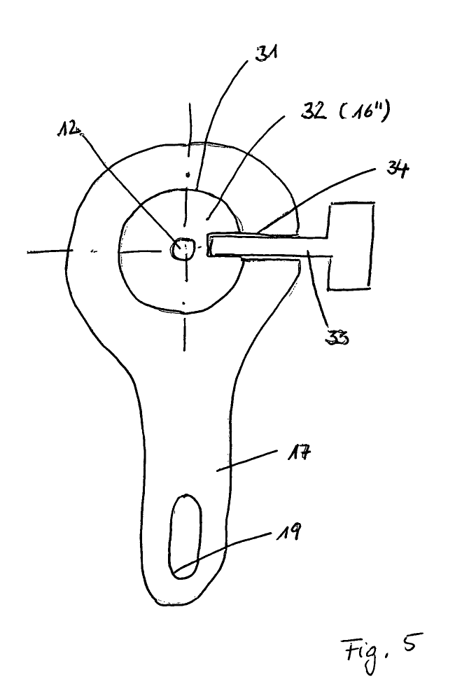

So that a vehicle occupant can actuate the clamping means in a simple way, a lever 17 is provided. One end of the lever 17 is operatively connected to the tension means 16′ and 16″, while the other end of the lever 17 projects into the vehicle interior so that it can be actuated in a simple way. The lever 17, then, is explained in more detail in conjunction with FIGS. 3 and 4.

The lever 17 has an elongate, essentially rectangular shape. Recesses 18 and 19 are provided at both ends. The lever 17 has in its middle region a step 21. The step 21 serves for guiding the lever 17 in its installation position around the steering column tube 8. A u-shaped receptacle 22 is provided in the region of the upper recess 18. The receptacle is distinguished by a web 23 running, u-shaped, around the recess 18 and having an undercut. The undercut generates a guide groove 24 which is delimited on one side by the web 23 and on the other side by the lever 17. The receptacle 22 being configured, as just described, this affords the possibility of a positive reception of a connection element which has a degree of freedom with respect to the lever 17, specifically the receptacle 22 allows a displacement of the lever 17 in the direction of the arrow A. The recess 19 serves for the reception of connection means not of any more detailed interest in connection with the invention and will therefore not be described any further here.

A nose 25, pointing in the direction of the arrow A, is arranged, level with the recess 18, on that side of the u-shaped receptacle 22 which is open. The nose 25 has a recess 26. The recess 26 serves for receiving a pin, not illustrated in any more detail, which makes a connection between the lever 17 and the tension means 16. The function of this connection is described in more detail below. Furthermore, the nose 25 has, on two opposite sides, notches 27 which contribute to a defined material failure of the nose 25. FIG. 4 illustrates the rear side of the lever 17 illustrated in FIG. 3. The recesses 18 and 19 and also the step 21 can be seen. Furthermore, the nose 25 with the recess 26 and with the notches 27 is illustrated. At the edge of the recess 18, on the side facing the nose 25, a projection 28 is provided, which has ribs 29 for stabilization. The ribs 29 are arranged on that side of the projection 28 which lies opposite the recess 18. Via the projection 28, a bearing connection can be made between the lever 17 and the console 2. The functioning of the projection 18 is likewise explained in more detail below.

The functioning of the steering column arrangement according to the invention is now described.

In normal use, the steering column 7 of the steering column arrangement 1 can be varied both in its inclination and in its length. For this purpose, the lever 17 must be actuated at its end pointing downward, that is to say must be displaced in the direction of the arrow B according to FIG. 1. The displacement causes a pivoting of the lever 17. Since the lever 17 is connected via its receptacle 22 to a corresponding connection element 31 (cf. FIG. 2) for the disk 16″ of the clamping means 16, the displacement of the lever 17 causes a rotation of the disk 16″ in relation to the disk 16′. As a result of the rotation of the disk 16″ in relation to the disk 16′ the distance between the two disks is varied—the disks 16′ and 16′ slip nearer to one another. As a result, the clamping built up by the lamellae 13′ and 13″ is released and a pivoting of the steering column tube 8 in relation to the console 2 fixed with respect to the vehicle becomes possible. As soon as the optimum position of the steering column 7 has been set, the lever 17 is actuated opposite to the direction of the arrow B, as a result of which, in turn, the disk 16″ is rotated in relation to the disk 16′ and the disks 16′ and 16″ move apart from one another. The lamellae 18′ and 18″ are thereby pushed together and the steering column is secured in its set position.

If, then, an axial force which overshoots a predetermined amount is applied to the steering column 7 in the event of an accident, the console slide 6 is released from the console 2 and a displacement of the steering column 7 in relation to the console 2 becomes possible. In order to prevent the clamping being released during this displacement, which would result in an undamped displacement of the steering column 7 in relation to the console 2, the projection 28 makes a connection between the lever 17 and the console 2. In this case, the console 2 prevents a further displacement of the lever 17. The lever 17 is therefore secured in relation to the console 2 via the projection 18. If, then, the force acting axially on the steering column 7 overshoots a particular amount, this leads to the release of the operative connection between the lever 17 and the tension means 16. The tension means 16, which are fixedly connected via the clamping bolt 12 to the advancing steering column 7, are in this case pushed out of the receptacle 22 of the lever. So that the push-out does not take place under the least possible force applied to the steering column 7, but, instead, only beyond a predetermined force, a connection between the lever 17 and the tension means 16 is made via the nose 25 and the pin mounted in the latter. The notches 27 introduced into the nose 25 are designed such that they free the pin beyond a specific force. This has the effect that a release of the tension means 16 from the receptacle 22 is possible only from the point when this predetermined force is overshot.

It is important in connection with the invention that the tension bolt 12 extends only as far as the tension means 16 and no longer through the lever 17. Owing to this feature, a release of the operative connection by virtue of a translational displacement of the steering column arrangement 7 in relation to the console 2 is possible.

A further embodiment of an actuation lever 17 according to the invention, then, is described below (cf. FIG. 5). As in the exemplary embodiment described above, one end of the lever 17 is operatively connected to the tension means 16, while the other end of the lever 17 projects into the vehicle interior. In the second exemplary embodiment, the operative connection between the lever 17 and clamping means 16 is made in that the lever 17 has a round recess 31, in which an integrally formed portion 32, likewise of round configuration, of the clamping means 16 is arranged. The round recess 31 and the integrally formed portion 32 are in this case coordinated with one another in their size such that they can move in relation to one another—a rotation of the lever 17 about the clamping means 16 is possible, without the clamping means being comoved. A securing of the two components in order to make the operative connection takes place via a cotter or a wire 33 which is arranged in a bore 34 extending through the lever 17 and the integrally formed portion 32 of the clamping means 16. This securing has the effect that, when the lever 17 is actuated, the clamping means 16 are comoved, thus leading to an opening or closing of the clamping means 16 and to the above described options with regard to the comfort adjustment of the steering column. The cotter or wire 33 is connected to the console 2 via connection means illustrated diagrammatically. The connection means may be, for example, the continuation of the wire 33.

If, then, an axial force which overshoots a predetermined amount is applied to the steering column 7 in the event of an accident, then, as already described, the console slide 6 is released from the console 2 and a displacement of the steering column 7 in relation to the console 2 becomes possible. In order to prevent the clamping from being released during this displacement, the cotter or wire 33 is connected to the console 2. If, then, the steering column 7 on which the clamping means 16 are arranged is moved in relation to the console 2, in this exemplary embodiment the lever 17, too, is commoved. However, the cotter or wire 33 remains stationary. On account of this relative movement, the wire 33 comes loose from the bore 34 and consequently frees movement between the lever 17 and the clamping means 16. The result of this, then, is that the clamping remains closed, irrespective of how the lever 17 is moved in relation to the clamping means 16. The risk of the uncontrolled opening of the clamping during a displacement of the steering column 7 in the event of an accident is thus reliably prevented.

1-10. (canceled)

11. A steering column arrangement comprising:
a console arranged fixedly with respect to a vehicle,
a steering column which has a steering column tube and a steering spindle mounted rotatably in the latter, the steering column being designed to be variable in its inclination and length,
clamping means for securing the steering column,
a console slide via which the steering column is connected to the console by the clamping means, the console slide being mounted displaceably on the console, and
an actuation element operatively connected by a releasable operative connection to the clamping means for releasing and locking the clamping means.

12. The steering column arrangement as claimed in claim 11, wherein the operative connection is released in the event of a displacement of the console slide in relation to the console.

13. The steering column arrangement as claimed in claim 11, wherein the clamping means have lamellae which overlap one another and through which a tension bolt passes.

14. The steering column arrangement as claimed in claim 13, wherein the clamping means have tension means cooperating with the tension bolt.

15. The steering column arrangement as claimed in claim 14, wherein the tension means have link disks displaceable relative to one another.

16. The steering column arrangement as claimed in claim 14, wherein the actuation element is an actuation lever.

17. The steering column arrangement as claimed in claim 16, wherein the actuation lever is in positive contact with the tension means.

18. The steering column arrangement as claimed in claim 16, wherein the actuation lever has a unshaped receptacle for a corresponding connection element of the tension means.

19. The steering column arrangement as claimed in claim 18, wherein the receptacle is oriented such that a release of a connection between the actuation lever and the tension means takes place in the event of a displacement of the console slide in relation to the console.

20. The steering column arrangement as claimed in claim 16, wherein the actuation lever has a dog which cooperates with the console in the event of a displacement of the console slide in relation to the console.

21. The steering column arrangement as claimed in claim 12, wherein the clamping means have lamellae which overlap one another and through which a tension bolt passes.

22. The steering column arrangement as claimed in claim 21, wherein the clamping means have tension means cooperating with the tension bolt.

23. The steering column arrangement as claimed in claim 22, wherein the tension means have link disks displaceable relative to one another.

24. The steering column arrangement as claimed in claim 15, wherein the actuation element is an actuation lever.

25. The steering column arrangement as claimed in claim 24, wherein the actuation lever is in positive contact with the tension means.

26. The steering column arrangement as claimed in claim 17, wherein the actuation lever has a unshaped receptacle for a corresponding connection element of the tension means.

27. The steering column arrangement as claimed in claim 26, wherein the receptacle is oriented such that a release of a connection between the actuation lever and the tension means takes place in the event of a displacement of the console slide in relation to the console.

28. The steering column arrangement as claimed in claim 17, wherein the actuation lever has a dog which cooperates with the console in the event of a displacement of the console slide in relation to the console.

29. The steering column arrangement as claimed in claim 18, wherein the actuation lever has a dog which cooperates with the console in the event of a displacement of the console slide in relation to the console.

30. The steering column arrangement as claimed in claim 19, wherein the actuation lever has a dog which cooperates with the console in the event of a displacement of the console slide in relation to the console.
